(19) United States
(12) Patent Application Publication
(10) Pub. No.: US 2014/0092811 A1
(43) Pub. Date: Apr. 3, 2014

(54) METHOD FOR TRANSMITTING CHANNEL STATUS INFORMATION AND USER EQUIPMENT, AND METHOD FOR RECEIVING CHANNEL STATUS INFORMATION AND BASE STATION

(71) Applicants: Kitae Kim, Anyang-si (KR); Jinyoung Chun, Anyang-si (KR); Sunam Kim, Anyang-si (KR); Jiwon Kang, Anyang-si (KR); Binchul Ihm, Anyang-si (KR); Sungho Park, Anyang-si (KR)

(72) Inventors: Kitae Kim, Anyang-si (KR); Jinyoung Chun, Anyang-si (KR); Sunam Kim, Anyang-si (KR); Jiwon Kang, Anyang-si (KR); Binchul Ihm, Anyang-si (KR); Sungho Park, Anyang-si (KR)

(73) Assignee: LG ELECTRONICS INC., Seoul (KR)

(21) Appl. No.: 14/115,558

(22) PCT Filed: Nov. 28, 2011
(86) PCT No.: PCT/KR2011/009116

§ 371 Date: Dec. 16, 2013

Related U.S. Application Data
(60) Provisional application No. 61/482,221, filed on May 4, 2011.
(60) Provisional application No. 61/491,853, filed on May 31, 2011.

(51) Int. Cl. H04W 24/02

(52) U.S. Cl. CPC H04W 24/02
USPC 370/328

(57) ABSTRACT

Disclosed are a method and an apparatus for transmitting/receiving channel status information on at least one of a plurality of nodes in a multi-node system. According the present invention, a channel status between a UE and a node which transmits data to the UE can be reported more accurately.

### TECHNICAL FIELD

The present invention relates to a wireless communication system. More specifically, the invention relates to methods and apparatuses for transmitting/receiving channel status information in a multi-node system supporting multi-node coordinated transmission.

### BACKGROUND ART

Machine-to-machine (M2M) communications, and a variety of devices and technologies such as smart phone, tablet PC, etc., which require large data capacity, have been developed and propagated. This rapidly increases the quantity of data which needs to be processed in a cellular network. To satisfy this rapidly increasing data throughput, various technologies are developed which include carrier aggregation and cognitive radio technique for efficiently using a larger number of frequency bands, and multi-antenna schemes and multi-base-station coordination for increasing the capacity of data transmitted within a limited frequency band.

In the meantime, communication environments are being evolved such that the density of nodes accessible by a user increases. A communication system having a high node density can provide a communication service of higher performance to users according to coordination of nodes. A multi-node coordinated communication scheme in which a plurality of nodes communicate with user equipment (UE) using the same time-frequency resource has data throughput much higher than that of the conventional communication scheme in which each node operates as an independent base station to communicate with a UE.

A multi-node system performs coordinated communications using a plurality of nodes each of which operates as a base station, an access point, an antenna, an antenna group, a radio remote header (RRH), or a radio remote unit (RRU). Distinguished from the conventional centralized antenna system in which antennas are concentrated on a base station, nodes are spaced apart in the multi-node system. The nodes can be managed by one or more base stations or base station controllers which control operations of the nodes or schedule data transmitted/received through the nodes. Each node is connected to a base station or a base station controller which manages the node through a cable or a dedicated line.

The multi-node system can be considered as a kind of Multiple Input Multiple Output (MIMO) system since distributed nodes can communicate with a single user or multiple users by transmitting/receiving different data streams simultaneously. However, since the multi-node system transmits signals using the distributed nodes, a transmission area covered by each antenna is reduced compared to antennas included in the conventional centralized antenna system. Accordingly, transmit power required for each antenna to transmit a signal in the multi-node system can be reduced compared to the conventional centralized antenna system using MIMO. In addition, a transmission distance between an antenna and a UE is reduced to result in a decrease in pathloss and to enable rapid data transmission in the multi-node system. This can improve transmission capacity and power efficiency of a cellular system and meet communication performance having relatively uniform quality regardless of user locations in a cell. Further, the multi-node system reduces signal loss happening during a transmission since base station(s) or base station controller(s) connected to a plurality of nodes transmit/receive data in cooperation with each other. When nodes spaced apart by over a predetermined distance perform coordinated communications with a UE, correlation and interference between antennas are reduced. Therefore, a high signal to interference-plus-noise ratio (SINR) can be obtained according to the multi-node coordinated communication scheme.

Owing to these advantages, the multi-node system is used with or replaces the conventional centralized antenna system to become a new foundation of cellular communications in order to reduce base station installation cost and backhaul network maintenance cost while extending service coverage and improving channel capacity and SINR in next-generation mobile communication systems.

### DISCLOSURE OF INVENTION

### Technical Problem

When a base station or a base station controller needs to efficiently transmit a signal to a UE through coordination transmission using some of a plurality of nodes located around the UE, the base station or the base station controller should know information about states of channels generated between the some nodes and the UE. A method for deriving channel information for a plurality of nodes has not been defined so far because the multi-node system was not considered. Therefore, it is necessary to define a method for measuring/reporting channel status information about some of a plurality of nodes distributed in the multi-node system, which is performed by a UE.

It is to be understood that objects to be achieved by the present invention are not limited to the aforementioned objects and other objects which are not mentioned will be apparent to those of ordinary skill in the art to which the present invention pertains from the following description.

### Solution to Problem

In accordance with one aspect of the present invention to achieve the objects, a method for transmitting channel status information at a user equipment (UE) capable of receiving signals from a plurality of nodes to a base station (BS) which controls at least one of the plurality of nodes includes: receiving from the BS node information which indicates one or more nodes for channel status information report by the UE from among the plurality of nodes; calculating the channel status information on the one or more nodes, treating a node other than the one or more nodes from among the plurality of nodes as an interfering node or a non-interfering nodes; and transmitting the calculated channel status information to the BS.

In accordance with another aspect of the present invention to achieve the objects, a method for receiving channel status information at a BS which controls at least one of a plurality of nodes from a UE capable of receiving signals from the plurality of nodes includes: transmitting to the UE node information which indicates one or more nodes for channel status information report by the UE from among the plurality of nodes; and receiving from the UE the channel status information on the one or more nodes, calculated by treating a node other than the one or more nodes from among the plurality of nodes as an interfering node or a non-interfering node.

In accordance with another aspect of the present invention to achieve the objects, a UE adapted to receive signals from a plurality of nodes and transmit channel status information to a BS which controls at least one of the plurality of nodes includes: a radio frequency (RF) configured to transmit/receive signals; and a processor connected to the RF unit and configured to control the RF unit, wherein the RF unit receives from the BS node information which indicates one or more nodes for channel status information report by the UE from among the plurality of nodes, and the processor is configured to calculate the channel status information on the one or more nodes by treating a node other than the one or more nodes from among the plurality of nodes as an interfering node or a non-interfering node and to control the RF unit to transmit the calculated channel status information to the BS.

In accordance with another aspect of the present invention to achieve the objects, a BS adapted to control at least one of a plurality of nodes and receive channel status information from a UE capable of receiving signals from the plurality of nodes includes: an RF unit configured to transmit/receive signals; and a processor connected to the RF unit and configured to control the RF unit, wherein the processor controls the RF unit to transmit to the UE node information which indicates one or more nodes for channel status information report by the UE from among the plurality of nodes, and controls the RF unit to receive from the UE the channel status information on the one or more nodes, calculated by treating a node other than the one or more nodes from among the plurality of nodes as an interfering node or a non-interfering node.

In the aspects of the present invention, the channel status information on the one or more nodes may be calculated on the assumption that the other node interferes with the one or more nodes when the other node is treated as the interfering node, and calculated on the assumption that the other node does not interfere with the one or more nodes when the other node is treated as the non-interfering node.

In the aspects of the present invention, treatment information which indicates whether the other node corresponds to the interfering node or the non-interfering node may be transmitted from the BS to the UE, and the UE may treat the other node as the interfering node or the non-interfering node on the basis of the treatment information.

In the aspects of the present invention, treatment information which indicates whether the other node has been treated as the interfering node or the non-interfering node when the channel status information on the one or more nodes is calculated may be transmitted from the UE to the BS.

The aforementioned technical solutions are only a part of the embodiments of the present invention, and various modifications to which technical features of the present invention are applied could be understood by those of ordinary skill in the art to which the present invention pertains, based on the following detailed description of the present invention.

### Advantageous Effects of Invention

According to embodiments the present invention, a UE can calculate a channel status between the UE and a node which transmits data to the UE more accurately and report the channel status to a base station or a base station controller.

Furthermore, the base station or base station controller can communicate with UE(s) located in a cell corresponding to the base station or base station controller through a plurality of nodes controlled by the base station or base station controller because the base station or base station controller can recognize channel status more accurately.

That is, data processing capability of the multi-node system can be improved.

It will be appreciated by persons skilled in the art that the effects that could be achieved with the present invention are not limited to what has been particularly described hereinabove and other advantages of the present invention will be more clearly understood from the following detailed description taken in conjunction with the accompanying drawings.

### BRIEF DESCRIPTION OF DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates an exemplary configuration of a multi-node system;

FIG. 2 illustrates an exemplary inter-node coordinated transmission;

FIG. 3 is a flowchart illustrating transmission of channel status information according to an embodiment of the present invention;

FIG. 4 is a flowchart illustrating transmission of channel status information according to another embodiment of the present invention;

FIG. 5 is a flowchart illustrates transmission of channel status information according to another embodiment of the present invention; and

FIG. 6 is a block diagram illustrating components of user equipment (UE) and a base station (BS).

### MODE FOR THE INVENTION

Hereinafter, the preferred embodiments of the present invention will be described with reference to the accompanying drawings. It is to be understood that the detailed description, which will be disclosed along with the accompanying drawings, is intended to describe the exemplary embodiments of the present invention, and is not intended to describe a unique embodiment with which the present invention can be carried out. The following detailed description includes detailed matters to provide full understanding of the present invention. However, it will be apparent to those skilled in the art that the present invention can be carried out without the detailed matters.

In some cases, to prevent the concept of the present invention from being ambiguous, structures and apparatuses of the known art will be omitted, or will be shown in the form of a block diagram based on main functions of each structure and apparatus. Also, wherever possible, the same reference numbers will be used throughout the drawings and the specification to refer to the same or like parts.

In the present invention, a User Equipment (UE) denotes a mobile or fixed type user terminal. Examples of the UE include various equipments that transmit and receive user data and/or various kinds of control information to and from a base station. The UE may be referred to as, a Terminal Equipment (TE), a Mobile Station (MS), a Mobile Terminal (MT), a User Terminal (UT), a Subscriber Station (SS), a wireless device, a Personal Digital Assistant (PDA), a wireless modem, or a handheld device. Also, in the present invention, a Base Station (BS) means a fixed station that performs communication with a user equipment and/or another base station, and exchanges various kinds of data and control information with the user equipment and another base station. The base station may be referred to another terminology such as an ABS (Advanced Base Station), a NB (Node-B), Evolved-NodeB (eNB), a Base Transceiver System (BTS), and an Access Point (AP).

In the present invention, the term Frame refers to a structured data sequence that has a fixed duration used in some physical (PHY) layer standards. One frame may include a specific number of subframes, each of which may include one or more slots. One subframe/slot may be configured so as to include a plurality of OFDM symbols in the time domain. For example, one subframe may be constructed of 2 slots, each including 7 OFDM symbols. The number of subframes per frame, the number of slots per subframe, and the number of OFDM symbols per slot are determined according to the physical standard of a corresponding system.

In the present invention, the term PDSCH (Physical Downlink Shared Channel) refers to a set of time-frequency resources that carry downlink data. In the present invention, when it is said that a UE transmits a PDSCH, this means that a downlink data signal is transmitted in a PDSCH.

In the present invention, the term Interfering Node refers to a node which interferes with a target node for which channel status measurement/report is required, and the term Non-Interfering Node refers to a node which does not interfere with the target node. In other words, when a signal transmitted/received by a specific node interferes with a signal transmitted/received by the target node, the specific node corresponds to an interfering node for the target node. On the other hand, when a signal transmitted/received by a specific node does not interfere with a signal transmitted/received by the target node, or interference of the signal is small enough to be ignored, the specific node becomes a non-interfering node for the target node. In the present invention, when a specific node is considered to be an interfering node, a UE measures/calculates channel status information for the target node on the assumption that a signal transmitted/received by the specific node interferes with a signal transmitted/received by the target node. If the specific node is considered to be a non-interfering node, the UE measures/calculates channel status information about the target node on the assumption that the signal transmitted/received by the specific node does not interfere with the signal transmitted/received by the target node.

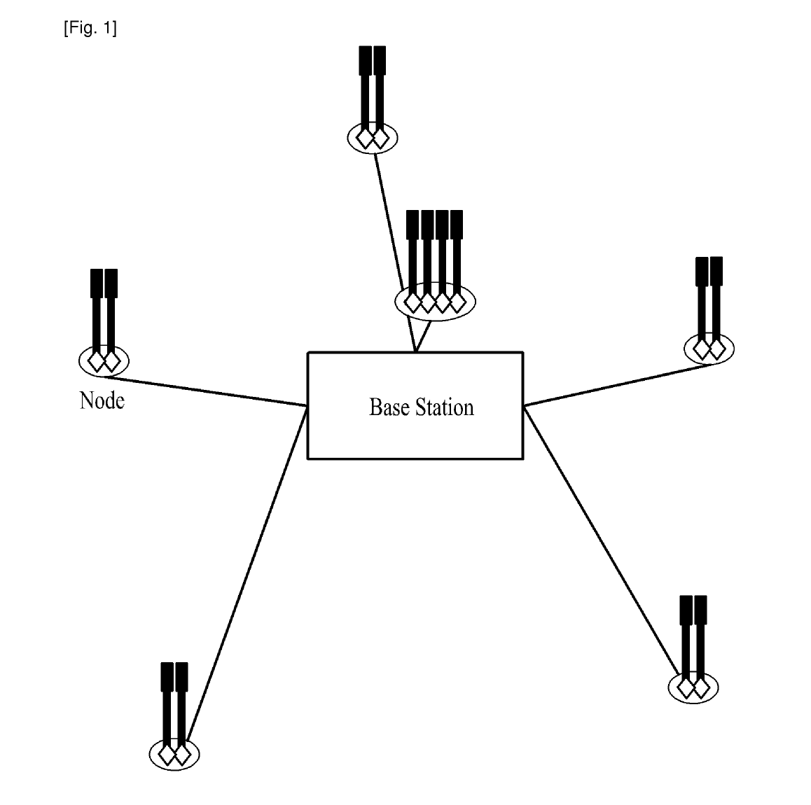

FIG. 1 illustrates an exemplary configuration of a multi-node system, particularly, a distributed multi-node system (DMNS).

Referring to FIG. 1, a plurality of nodes spaced apart and arranged in a predetermined geographical area are linked to one BS or BS controller through cables or dedicated lines in the DMNS. That is, one controller manages transmission/reception through all the nodes located in the predetermined geographical area.

If the nodes have the same cell identifier (ID) in the DMNS, that is, if the same cell ID is used for signal transmission through the nodes, each node serves as a group of some antennas of one cell in the DMNS. Each node may be given a node ID, or may operate as an antenna in the cell without a node ID in the DMNS.

If the nodes have different cell IDs in the DMNS, this DMNS can be considered as a multi-cell (e.g., macro-cell/femto-cell/pico-cell) system. When multiple cells respectively formed by the plurality of nodes are arranged in coverages in an overlaying manner, a network constructed by the multiple cells is called a multi-tier network.

Only distributed antennas or antenna groups do not become nodes. A variety of BSs can be used as nodes regardless of their names. That is, BS, NB, eNB, pico-cell eNB (PeNB), home eNB (HeNB), RRH, RRU, relay, repeater, etc. can be used as nodes. At least one antenna is installed for one node. The antenna may be a physical antenna, an antenna port, a virtual antenna, or an antenna group. A node may be called a point.

FIG. 1 shows a case in which one controller manages transmission/reception through all the nodes located in the predetermined geographical area. However, nodes which perform coordinated communication do not have to be managed only by one controller. Embodiments of the present invention can be applied to a case in which nodes controlled by different BSs or BS controllers perform coordinated communication. In other words, in the multi-node system according to the present invention, one or more BSs or BS controllers connected to the plurality of nodes can control the plurality of nodes to simultaneously transmit signals to UE(s) or simultaneously receive signals from the UE(s) through some of the plurality of nodes.

While multi-node systems are distinguished according to the nature and implementation form of each node, the multi-node systems are different from single-node systems (e.g., CAS, conventional MIMO system, conventional relay system, conventional repeater system, etc.) since a plurality of nodes participate together in a process of providing a communication service to UEs over a certain time-frequency resource. Accordingly, methods for performing coordinated transmission of data using all or some of a plurality of nodes according to embodiments of the present invention can be applied to various types of multi-node systems. Though a node generally refers to an antenna group spaced apart from other nodes by over a predetermined distance, the following embodiments of the present invention can be applied to any antenna group regardless of spacing. For instance, in the case of a BS including cross polarized (X-pol) antennas, the embodiments of the present invention can be applied on the assumption that the BS controls a node configured with H-pol antennas and a node configured with V-pol antennas.

A technique of transmitting/receiving data through a plurality of transmission (Tx)/receiving (Rx) nodes is referred to as multi-BS MIMO or Coordinated multi-point Tx/Rx (CoMP). Among these multi-point coordinated communications, coordinated transmission schemes can be largely divided into Joint Processing (JP) and scheduling coordination. The former can be classified into Joint Transmission (JT) and Dynamic Cell Selection (DCS) and the latter can be classified into Coordinated Scheduling (CS) and Coordinated Beamforming (CB). Among the multi-node coordinated communication schemes, JP can establish various communication environments.

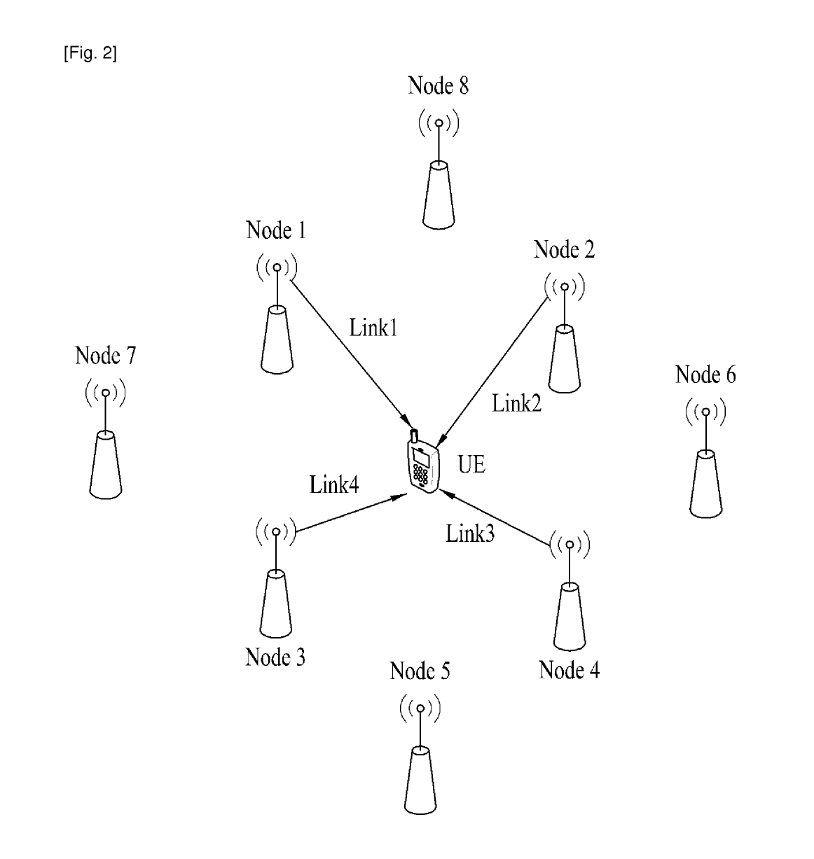

FIG. 2 illustrates an exemplary multi-node coordinated transmission.

Referring to FIG. 2, a plurality of nodes Node 1 to Node 8 are located around a UE, and some Node 1, Node 2, Node 3 and Node 4 of them can be JP candidate nodes which can perform JP for the UE. For instance, when intensities of signals transmitted from Node 1, Node 2, Node 3 and Node 4 are relatively higher, Node 1, Node 2, Node 3 and Node 4 can be JP candidate nodes for the UE. Let a set including Node 1, Node 2, Node 3 and Node 4 be node set A. The UE reports channel status information on the nodes of node set A to a network. That is, the UE transmits the channel status information on the nodes of node set A to a BS linked with the UE. The network performs scheduling for the UE on the basis of the channel status information. To reduce scheduling complexity in the network, the network needs to freely use the nodes. In other words, the network has to freely select nodes to which data transmission is assigned. This means that channel status information that the UE should report to the BS may have various forms. For example, the BS can involve Node 1 and Node 2 of node set A in data transmission to the UE in a predetermined period (e.g., subframe #1) and involve Node 1 and Node 4 of node set A in data transmission to the UE in another predetermined period (e.g., subframe #2) according to the scheduling result of the network. To allow the network to perform flexible scheduling in this manner, the UE preferably feeds back to the network both channel status information on Node 1 and Node 2 and channel status information on Node 1 to Node 4. However, since legacy communication standards did not consider the multi-node system, a method for estimating channel states with respect to some of nodes in the multi-node system has not been defined.

Accordingly, the present invention proposes a scheme for measuring channel status information on some of nodes in a multi-node system more accurately. In the present invention, channel status information refers to information capable of representing the quality of a radio channel (or link) established between a UE and a node. For instance, the channel status information may be a Channel Quality Indicator (CQI), Rank Index (RI), and/or Precoding Matrix Index (PMI). While calculation and/or transmission of a CQI are described in the following embodiments of the present invention, the embodiments of the present invention can be applied to calculation and/or transmission of channel status information of other types such as RI and PMI.

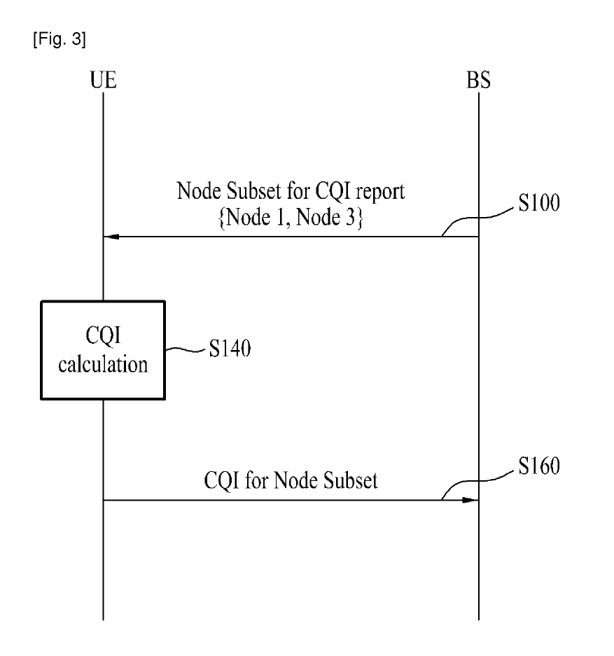

FIG. 3 is a flowchart illustrating transmission of channel status information according to an embodiment of the present invention.

Referring to FIGS. 2 and 3, when the UE enters the network established by the JP candidate nodes Node 1, Node 2, Node 3 and Node 4 which can perform JP, that is, when the UE access a BS which controls all or some of the JP candidate nodes Node 1, Node 2, Node 3 and Node 4, the BS requests the UE to report CQI with respect to node(s), which will be actually used or has a chance of being used to transmit data to the UE, from among the JP candidate nodes (S100). For instance, when the BS transmits data to the UE through JP using Node 1 and Node 3, the BS can request the UE to transmit thereto CQI with respect to Node 1 and Node 3.

The UE receives the CQI report request from the BS (S100) and calculates CQI for a subset of Node 1 and Node 3 (S140). The UE according to the present invention calculates the CQI for the node subset by treating all or some of the remaining nodes Node 2 and Node 4 of the JP candidate nodes, which do not associated with CQI report requested by the BS, as an interfering node or a non-interfering node. When calculating CQI for the subset {Node 1, Node 3} from among the node set {Node 1, Node 2, Node 3, Node 4}, the UE considers all the remaining nodes {Node 2, Node 4} other than the subset {Node 1, Node 3} as interfering nodes and reflects signal intensities of Node 2 and Node 4 in the interference on signals of Node 1 and Node 3. Alternatively, the UE considers Node 2 and Node 4 as non-interfering nodes and calculates CQI for the subset {Node 1, Node 3} on the assumption that Node 2 and Node 4 do not interfere with the subset {Node 1, Node 3}. Though the UE can consider all the remaining nodes other than the node subset as interfering nodes or non-interfering nodes when calculating the CQI for the node subset, the UE can treat the remaining nodes separately. For example, when the UE calculates the CQI with respect to the node subset {Node 1, Node 3} from among the JP candidate node set {Node 1, Node 2, Node 3, Node 4}, the UE can considers Node 2 from among the remaining nodes to be an interfering node and consider Node 4 to be a non-interfering node. When categorizing the remaining nodes Node 2 and Node 4 other than the node subset {Node 1, Node 3} into an interfering node/non-interfering node, the UE can take into account the signal intensities of the remaining nodes. For instance, the UE can determine the remaining nodes as interfering nodes when their signal intensities are higher than a predetermined reference value and determine them as non-interfering nodes when their signal intensities are lower than the reference value.

The UE feeds back/transmits the CQI calculated for the subset {Node 1, Node 3} to the BS (S160).

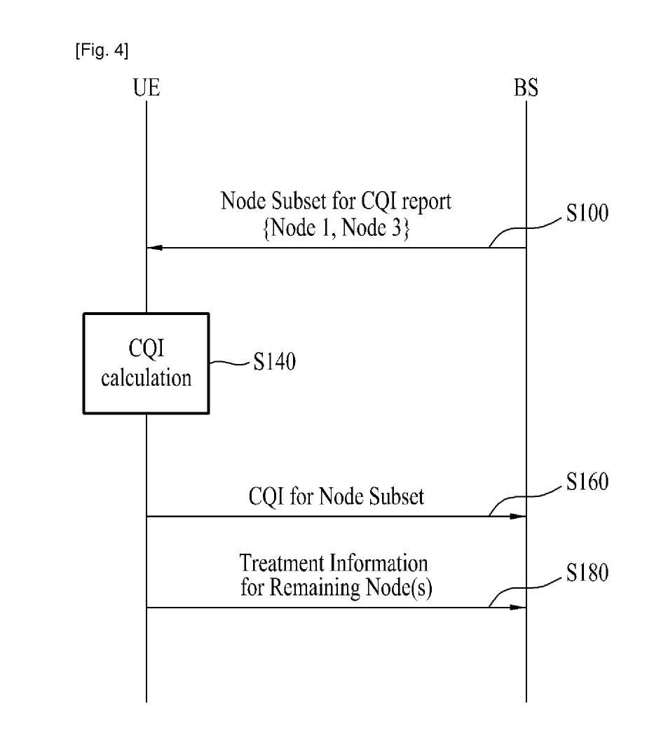

FIG. 4 is a flowchart illustrating transmission of channel status information according to another embodiment of the present invention.

Referring to FIG. 4, as in the embodiment of FIG. 2, the BS can notify the UE of the node subset {Node 1, Node 3} for CQI report from among the JP candidate node set {Node 1, Node 2, Node 3, Node 4} (S100). The UE calculates CQI for the node subset {Node 1, Node 3}, considering Node 2 and Node 4 other than the node subset {Node 1, Node 3} as an interfering node or a non-interfering node (S140), and reports the calculated CQI to the BS (S160). Herein, the UE transmits to the BS treatment information which represents whether the remaining nodes {Node 2, Node 4} have been treated as interfering nodes or non-interfering nodes during the calculation of CQI for the node subset {Node 1, Node 3} together with the CQI or additionally (S180). When the UE determines that the remaining nodes Node 2 and Node 4 are treated separately, the treatment information can represent how Node 2 and Node 4 have been treated respectively.

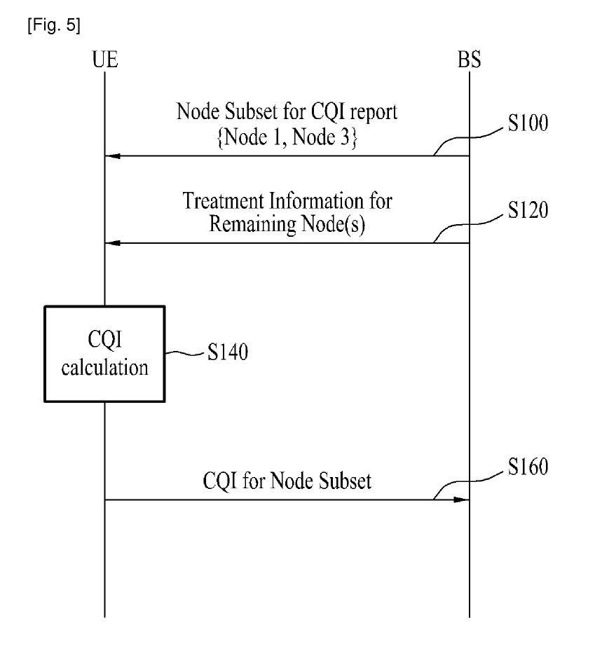

FIG. 5 is a flowchart illustrating transmission of channel status information according to another embodiment of the present invention.

Referring to FIG. 5, as in the embodiments described with reference to FIGS. 3 and 4, the BS can notify the UE of the node subset {Node 1, Node 3} for CQI report from among the JP candidate node set {Node 1, Node 2, Node 3, Node 4} (S100). The UE calculates CQI for the node subset {Node 1, Node 3}, considering Node 2 and Node 4 other than the node subset {Node 1, Node 3} as an interfering node or a non-interfering node (S140), and reports the calculated CQI to the BS (S160). In the embodiment of the present invention, the network determines treatment of the remaining nodes Node 2 and Node 4 and notifies the UE of the determination result, distinguished from the embodiment of FIG. 4 in which the UE determines treatment of the remaining nodes. The network determines whether or not downlink data is allocated to one or both of the remaining nodes Node 2 and Node 4 when JP is performed for the UE through the node subset {Node 1, Node 3}. When downlink signals are allocated to both the remaining nodes Node 2 and Node 4, the BS in the network transmits to the UE treatment information which represents that both the remaining nodes Node 2 and Node 4 need to be treated as interfering nodes (S120). On the contrary, when downlink signals are not allocated to both the remaining nodes Node 2 and Node 4, the BS in the network transmits to the UE treatment information which represents that both the remaining nodes Node 2 and Node 4 need to be treated as non-interfering nodes (S120).

The BS can determine treatment of the remaining nodes Node 2 and Node 4 separately or as a whole. For instance, the BS can instruct the UE to treat Node 1, Node 2 and Node 3 as interfering nodes when they do not belong to a subset of the candidate node set {Node 1, Node 2, Node 3, Node 4} and to treat Node 4 as a non-interfering node when it does not belong to the subset. Otherwise, the BS can instruct the UE to treat Node 2 as an interfering node and treat Node 4 as a non-interfering node when calculating CQI for the node subset {Node 1, Node 3}. In this case, the UE requested by the BS to report the calculated CQI for the node subset {Node 1, Node 3} can reflect the signal intensity of Node 2 in interference on signals of the node subset {Node 1, Node 3} when calculating the CQI for the node subset {Node 1, Node 3}, considering Node 2 as an interfering node and considering Node 4 as a non-interfering node. When categorizing the remaining nodes Node 2 and Node 4 other than the node subset {Node 1, Node 3} into an interfering/non-interfering node, the BS can take into account the signal intensities of the remaining nodes. For instance, the BS can determine the remaining nodes as interfering nodes when their signal intensities are higher than a predetermined reference value and determine them as non-interfering nodes when their signal intensities are lower than the reference value.

The UE receives the treatment information about both or one of the remaining nodes from the BS, and calculates CQI for the node subset {Node 1, Node 3} considering both or one of the remaining nodes Node 2 and Node 4 as an interfering node or a non-interfering node according to the treatment information. Specifically, the UE reflects the signal intensity of a remaining node, indicated by the treatment information as an interfering node, in the interference on the signal of the node subset (S140) when calculating the CQI for the node subset. On the other hand, the UE calculates the CQI for the node subset on the assumption that a remaining node indicated by the treatment information as a non-interfering node does not interfere with the node subset when the remaining node is treated as a non-interfering node (S140). The UE transmits to the BS the CQI for the node subset {Node 1, Node 3}, which is obtained by treating both or one of the remaining nodes Node 2 and Node 4 as an interfering node or a non-interfering node based on the treatment information received from the BS. The UE may transmit to the BS treatment information, which represents how the UE has actually treated the remaining nodes Node 2 and Node 4 when calculating the CQI, together with the CQI or additionally.

The BS schedules data transmission to the UE on the basis of the CQI calculated according to the embodiments of FIGS. 3, 4 and 5. The BS can allocate downlink data to the nodes controlled by the BS in consideration of treatment of the remaining nodes Node 2 and Node 4. The BS may transmit data destined for a UE other than the UE through a node treated as an interfering node by the BS or the UE from among the remaining nodes other than the node subset. On the other hand, the BS does not transmit data to the other UE through a node treated as a non-interfering node by the BS or the UE. Otherwise, the BS may reduce or remove direct interference of the node treated as a non-interfering node in the node subset by decreasing the transmit power of the node to below a predetermined reference level, for example. Further, it is possible to prevent generation of interference in the UE using beamforming (including precoding scheme).

In the above-described embodiments of the present invention, the network can inform the UE of the candidate node set. The network can determine the candidate node set without feedback information from the UE or by selecting all or some of candidate nodes preferred by the UE and inform the UE of the determined candidate node set.

In the aforementioned embodiments of the present invention, when the JP candidate nodes are controlled by a plurality of BSs, the BS of the network in which the UE currently enters can be a serving BS. In other words, when a plurality of BS are coordinate to perform JP, the BS to which the UE connects becomes the serving BS of the UE, and thus the serving BS notifies the UE of a node subset for CQI report and receives the CQI for the node subset from the UE.

In the above-described embodiments of the present invention, channel status information on a specific node is measured using a reference signal (RS) which is usually transmitted over the whole band from the specific node. A cell-specific RS, a channel status information RS (CSI-RS), etc. can be used to calculate channel status information. Though the RS may be called a pilot, preamble, or mid-amble, a signal can be used as the RS of the present invention irrespective of the term thereof if the signal is used by the UE for channel estimation/measurement. To allow neighboring nodes in a multi-node system to transmit reference signals for channel measurement through different time-frequency resources, respectively, time-frequency resource sets which can carry the reference signals can be predefined in a predetermined resource region defined by a plurality of time-frequency resources. Accordingly, a predetermined number of neighboring nodes in the multi-node system can be configured to transmit their reference signals on different resource sets. The BS can notify the UE of time-frequency resource set(s) through which the node subset for CQI report transmits its reference signal. The UE can calculate the CQI for the node subset using signal(s) received through the time-frequency resource set(s) notified by the BS and transmit the CQI to the BS. In other words, the BS can request the UE to report CQI for the node subset by notifying the UE of the node subset for CQI report. Further, the BS can request the UE to report CQI for the node subset by informing the UE of a time-frequency resource set from which the UE should detect/receive signal(s) to be used for measurement of channel status information. The UE can transmit CQI for the node subset to a specific node or whole node of the node subset. The specific node may be a node through which the UE initially enters the network or a node through which the UE completes the access to the BS.

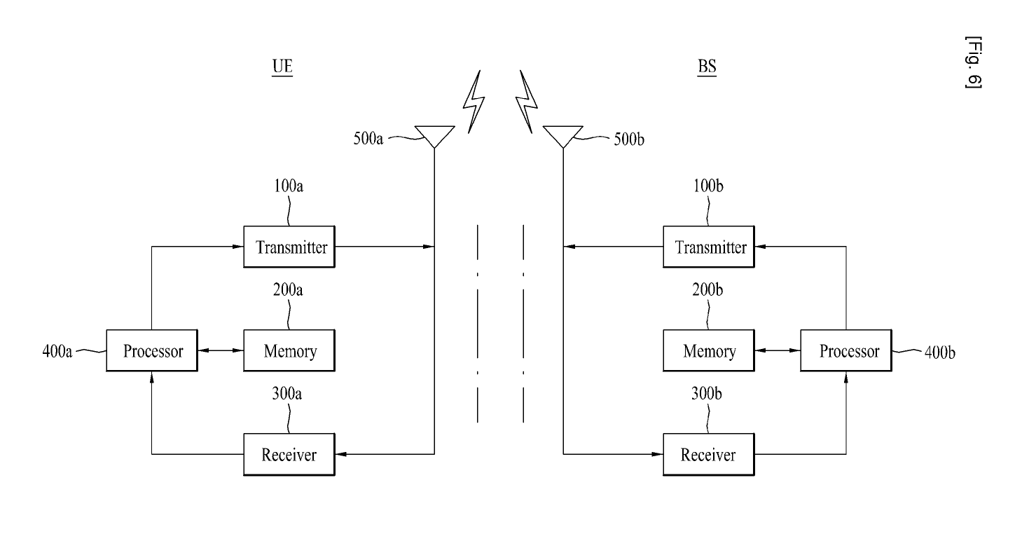

FIG. 6 is a block diagram of a UE and a BS for implementing the present invention.

The UE serves as a transmitter on the uplink and as a receiver on the downlink. In contrast, the BS may serve as a receiver on the uplink and as a transmitter on the downlink.

The UE and the BS include antennas 500a and 500b for receiving information, data, signals, and/or messages, transmitters 100a and 100b for transmitting messages by controlling the antennas 500a and 500b, receivers 300a and 300b for receiving messages by controlling the antennas 500a and 500b, and memories 200a and 200b for storing information associated with communication in the wireless communication system. The UE and the BS further include processors 400a and 400b, respectively, which are adapted to perform the present invention by controlling the components of the UE and the BS, such as the transmitters 100a and 100b, the receivers 300a and 300b, and the memories 200a and 200b. The transmitter 100a, the memory 200a, the receiver 300a, and the processor 400a in the UE may be configured as independent components on separate chips or their separate chips may be incorporated into a single chip. Likewise, the transmitter 100b, the memory 200b, the receiver 300b, and the processor 400b in the BS may be configured as independent components on separate chips or their separate chips may be incorporated into a single chip. The transmitter and the receiver may be configured as a single transceiver or a Radio Frequency (RF) module in the UE or the BS.

The memories 200a and 200b may store programs required for signal processing and controlling of the processors 400a and 400b and temporarily store input and output information. The memories 200a and 200b may store predefined codebooks with respect to each rank. Each of the memories 200a and 200b may be implemented into a flash memory-type storage medium, a hard disc-type storage medium, a multimedia card micro-type storage medium, a card-type memory (e.g. a Secure Digital (SD) or eXtreme Digital (XS) memory), a Random Access Memory (RAM), a Read-Only Memory (ROM), an Electrically Erasable Programmable Read-Only Memory (EEPROM), a Programmable Read-Only Memory (PROM), a magnetic memory, a magnetic disc, or an optical disk.

The antennas 500a and 500b transmit signals generated from the transmitters 100a and 100b to the outside, or transfer radio signals received from the outside to the receivers 300a and 300b. The antennas 500a and 500b may be referred as antenna ports. Each antenna port may correspond to one physical antenna or may be configured into a combination of more than one physical antenna element. In either case, the signal transmitted from each antenna port is not designed to be further deconstructed by the UE receiver (300a). The transmitted reference signal corresponding to a given antenna port defines the antenna port from the point of the UE, and enables the UE to derive a channel estimation for that antenna port, regardless of whether it represents a single radio channel from one physical antenna or a composite channel from a plurality of physical antenna elements together comprising the antenna port. If the transmitters 100a and 100b and/or the receivers 300a and 300b support a Multiple Input Multiple Output (MIMO) function using a plurality of antennas, each of them may be connected to two or more antennas.

All or some of antennas included in the BS can operate as nodes according to the embodiments of the present invention. The embodiments of the present invention can be applied to nodes spaced apart by over a predetermined distance among the nodes of the BS. Further, the embodiments of the present invention can be applied to nodes which are not spaced apart from among the nodes of the BS if the nodes can be used for coordinated transmission of data to the UE with different coverages. In addition, the embodiments of the present invention can be applied to nodes used for coordinated transmission together with nodes included in other BSs.

The processors 400a and 400b generally provide overall control to the modules of the UE and the BS. Especially, the processors 400a and 400b may carry out a control function for performing the present invention, a Medium Access Control (MAC) frame variable control function based on service characteristics and a propagation environment, a power saving mode function for controlling idle-mode operations, a handover function, and an authentication and encryption function. The processors 400a and 400b may also be referred to as controllers, microcontrollers, microprocessors, microcomputers, etc. The processors 400a and 400b may be configured in hardware, firmware, software, or their combination. In a hardware configuration, the processors 400a and 400b may be provided with one or more Application Specific Integrated Circuits (ASICs), Digital Signal Processors (DSPs), Digital Signal Processing Devices (DSPDs), Programmable Logic Devices (PLDs), and/or Field Programmable Gate Arrays (FPGAs), for implementing the present invention. In a firmware or software configuration, firmware or software may be configured to include a module, a procedure, a function, etc. for performing functions or operations of the present invention. This firmware or software may be provided in the processors 400a and 400b, or may be stored in the memories 200a and 200b and driven by the processors 400a and 400b.

The transmitters 100a and 100b perform predetermined coding and modulation for signals and/or data, which are scheduled by the processors 400a and 400b or schedulers connected to the processors 400a and 400b and transmitted to the outside, and then transfer the modulated signals and/or data to the antennas 500a and 500b. For example, the transmitters 100a and 100b convert a transmission data stream to K layers by demultiplexing, channel coding, modulation, etc. The K layers are transmitted through the antennas 500a and 500b after being processed in transmission processors of the transmitters 100a and 100b.

The signal processing procedure of the receivers 300a and 300b is the reverse of the signal processing procedure of the transmitters. Specifically, the receivers 300a and 300b perform decoding and demodulation of wireless signals received from the outside through the antennas 500a and 500b and deliver the resulting signals to the corresponding processors 400a and 400b. Each of the antennas 500a and 500b connected to the receivers 300a and 300b may include Nᵣ reception antennas. Each of the signals received through the reception antennas is reconstructed into a base band signal and is then reconstructed into a data stream, which was originally intended to be transmitted by the transmitters 100a and 100b, through multiplexing and MIMO demodulation.

The transmitters 100a and 100b and the receivers 300a and 300b of the UE and the BS may be configured in different manners depending on the procedures of processing transmitted signals and received signals.

Let modules including the transmitters 100a and 100b, the receivers 300a and 300b, and the antennas 500a and 500b be called radio frequency (RF) units.

The BS processor 400b of the present invention can determine candidate nodes which can be used for coordinated transmission of data to the UE with or without feedback information from the UE which has entered the network of the BS, or by selecting all or some of nodes requested by the UE. The BS processor 400b can control the BS transmitter 100b to transmit information indicating the candidate nodes to the UE. The BS processor 400b controls operations of one or more nodes linked to the BS. The BS processor 400b can perform coordinated transmission of data to the UE located in the coverage of the BS through two or more nodes belonging to the BS. Otherwise, the BS processor 400b can perform coordinated transmission of data to the UE through nodes belonging thereto and nodes belonging to other BS in cooperation with the processor of the other BS. Referring to FIGS. 3 and 5, the BS processor 400b of the present invention can determine a node subset for channel status information report, and control the BS transmitter 100b to transmit information indicating the determined node subset to the UE. The BS processor 400b according to the embodiment described with reference to FIG. 5 can treat the remaining nodes which do not belong to the node subset among the candidate nodes to be used for coordinated transmission of data to the UE, separately or as a whole. The BS processor 400b controls the BS transmitter 100b to transmit to the UE treatment information which represents that the remaining nodes are interfering nodes when they affect the node subset and indicates that the remaining nodes are non-interfering nodes when they do not affect the node subset. The UE receiver 300a according to the embodiments of FIGS. 3 and 5 receives the information on the node subset and the UE processor 400a measures channel status information for the node subset. The UE processor 400a can calculate the channel status information for the node subset using reference signals transmitted from the nodes belonging to the node subset. Here, the UE processor 400a calculates the channel status information for the node subset, treating a remaining node which does not belong to the node subset as an interfering node or a non-interfering nodes according to determination (described in the embodiment of FIG. 4) of the UE processor 400a or the treatment information (described in the embodiment of FIG. 5) received from the BS. The UE processor 400a controls the UE transmitter 100a to transmit the calculated channel status information to the BS. The UE processor 400a can control the UE transmitter 100a to transmit to the BS treatment information indicating whether a candidate node which does not belong to the node subset have been treated as an interfering node or a non-interfering node during the calculation of the channel status information. The BS receiver 300b can receive the channel status information transmitted from the UE. If the UE transmits the treatment information, the BS receiver 300b can receive it. The BS processor 400b performs scheduling for the UE on the basis of the channel status information. The BS processor 400b can allocate data to be transmitted to the UE to one or more nodes belonging to the node subset and control the corresponding nodes to transmit the allocated data to the UE. The BS processor 400b can reflect whether the remaining candidate node has been treated as interfering nodes in the scheduling. The BS processor 400b may allocate data to be transmitted to other UE to a candidate node treated as an interfering node and control the interfering node to transmit the data to the other UE. The BS processor 400b may prevent a candidate node treated as a non-interfering node from affecting signals transmitted to the UE by allocating no downlink signal to the corresponding candidate node, reducing the power of the corresponding candidate node to a predetermined reference level, or applying a beamforming scheme to data allocated to the corresponding candidate node.

In accordance with the embodiments of the present invention, the UE estimates a channel status with respect to a coordinated node used for coordinated transmission of data to the UE in consideration of the influence of a node other than the coordinated node on the coordinated node. Accordingly, the state of a channel between the UE and the node which transmits data to the UE can be calculated more accurately and reported to the BS.

Furthermore, according to the embodiments of the present invention, the BS performs scheduling on the basis of channel status information estimated in consideration of the influence of a node other than the coordinated node used for coordinated transmission of data to the UE on the coordinated node, and thus the BS can allocate/transmit data to UE(s) located in the cell controlled by the BS more efficiently.

That is, the data processing performance of the multi-node system can be improved according to the embodiments of the present invention.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

### INDUSTRIAL APPLICABILITY

The embodiments of the present invention can be applied to a BS, a UE, or other communication devices in a wireless communication system.

1. A method for transmitting channel status information at a user equipment (UE) capable of receiving signals from a plurality of nodes to a base station (BS) which controls at least one of the plurality of nodes, the method comprising:
receiving, from the BS, node information which indicates one or more nodes for channel status information report by the UE from among the plurality of nodes;
calculating the channel status information on the one or more nodes, treating a node other than the one or more nodes from among the plurality of nodes as an interfering node or a non-interfering nodes; and
transmitting the calculated channel status information to the BS.

2. The method according to claim 1, wherein the calculating of the channel status information calculates the channel status information on the one or more nodes on the assumption that the other node interferes with the one or more nodes when the other node is treated as the interfering node, and calculates the channel status information on the one or more nodes on the assumption that the other node does not interfere with the one or more nodes when the other node is treated as the non-interfering node.

3. The method according to claim 2, further comprising:
receiving, from the BS, treatment information which indicates whether the other node corresponds to the interfering node or the non-interfering node,
wherein the calculating of the channel status information treats the other node as the interfering node or the non-interfering node on the basis of the treatment information.

4. The method according to claim 1, further comprising:
transmitting, to the BS, treatment information which indicates whether the other node has been treated as the interfering node or the non-interfering node when the channel status information on the one or more nodes is calculated.

5. A method for receiving channel status information at a base station (BS) which controls at least one of a plurality of nodes from a user equipment (UE) capable of receiving signals from the plurality of nodes, the method comprising:
transmitting, to the UE, node information which indicates one or more nodes for channel status information report by the UE from among the plurality of nodes; and
receiving from the UE the channel status information on the one or more nodes, calculated by treating a node other than the one or more nodes from among the plurality of nodes as an interfering node or a non-interfering node.

6. The method according to claim 5, further comprising:
transmitting, to the UE, treatment information which indicates whether the other node corresponds to the interfering node or the non-interfering node.

7. The method according to claim 5, further comprising:
receiving, from the UE, treatment information which indicates whether the other node has been treated as the interfering node or the non-interfering node when the channel status information on the one or more nodes is calculated.

8. A user equipment (UE) adapted to receive signals from a plurality of nodes and transmit channel status information to a base station (BS) which controls at least one of the plurality of nodes, the UE comprising:
a radio frequency (RF) configured to transmit/receive signals; and
a processor connected to the RF unit and configured to control the RF unit,
wherein the RF unit receives, from the BS, node information which indicates one or more nodes for channel status information report by the UE from among the plurality of nodes, and the processor is configured to calculate the channel status information on the one or more nodes by treating a node other than the one or more nodes from among the plurality of nodes as an interfering node or a non-interfering node and to control the RF unit to transmit the calculated channel status information to the BS.

9. The UE according to claim 8, wherein the processor is configured to calculate the channel status information on the one or more nodes on the assumption that the other node interferes with the one or more nodes when the other node is treated as the interfering node, and calculate the channel status information on the one or more nodes on the assumption that the other node does not interfere with the one or more nodes when the other node is treated as the non-interfering node.

10. The UE according to claim 9, wherein the RF unit receives, from the BS, treatment information which indicates whether the other node corresponds to the interfering node or the non-interfering node, and the processor is configured to treat the other node as the interfering node or the non-interfering node on the basis of the treatment information when calculating the channel status information on the one or more nodes.

11. The UE according to claim 8, wherein the processor controls the RF unit to transmit, to the BS, treatment information which indicates whether the other node has been treated as the interfering node or the non-interfering node when the channel status information on the one or more nodes is calculated.

12. A base station (BS) adapted to control at least one of a plurality of nodes and receive channel status information from a user equipment (UE) capable of receiving signals from the plurality of nodes, the BS comprising:
an RF unit configured to transmit/receive signals; and
a processor connected to the RF unit and configured to control the RF unit,
wherein the processor controls the RF unit to transmit, to the UE, node information which indicates one or more nodes for channel status information report by the UE from among the plurality of nodes, and controls the RF unit to receive, from the UE, the channel status information on the one or more nodes, calculated by treating a node other than the one or more nodes from among the plurality of nodes as an interfering node or a non-interfering node.

13. The BS according to claim 12, wherein the processor controls the RF unit to transmit, to the UE, treatment information which indicates whether the other node corresponds to the interfering node or the non-interfering node.

14. The BS according to claim 11, wherein the RF unit receives, from the UE, treatment information which indicates whether the other node has been treated as the interfering node or the non-interfering node when the channel status information on the one or more nodes is calculated.
